(19) United States
(12) Patent Application Publication
(10) Pub. No.: US 2014/0358491 A1
(43) Pub. Date: Dec. 4, 2014

(54) SYSTEM AND METHOD FOR EDITING FEATURES

(71) Applicants: Dick Baardse, Geldermalsen (NL); Kishore Nimmagadda, Cincinnati, OH (US); Steve Marek, Lebanon, OH (US); Joseph Nemeth, Lebanon, OH (US)

(72) Inventors: Dick Baardse, Geldermalsen (NL); Kishore Nimmagadda, Cincinnati, OH (US); Steve Marek, Lebanon, OH (US); Joseph Nemeth, Lebanon, OH (US)

(73) Assignee: Siemens Product Lifecycle Management Software Inc., Plano, TX (US)

(21) Appl. No.: 13/905,279

(22) Filed: May 30, 2013

(51) Int. Cl. G06F 17/50

(52) U.S. Cl. CPC G06F 17/50
USPC 703/1

(57) ABSTRACT

Various disclosed embodiments include methods, systems, and computer-readable media for editing features using a PLM data processing system. A method includes receiving a geometric model including a plurality of parts. Each part includes one or more features having one or more feature attributes. Each part is stored within a separate part file. The method includes identifying a source feature in one of the parts. The source feature is associated with a modified feature attribute. The method includes identifying a compatible target feature in one or more of the parts. The method includes modifying a feature attribute of the target feature to correspond to the modified feature attribute that is associated with the source feature.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include methods for editing multiple features and corresponding systems and computer-readable mediums. A method includes receiving a geometric model including a plurality of parts. Each part includes one or more features having one or more feature attributes. Each part is stored within a separate part file. The method includes identifying a source feature in one of the parts. The source feature is associated with a modified feature attribute. The method includes identifying a compatible target feature in one or more of the parts. The method includes modifying a feature attribute of the target feature to correspond to the modified feature attribute that is associated with the source feature.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates a display of an assembly in a user interface for a multi-feature edit system in accordance with disclosed embodiments;

FIG. 3 illustrates a display of part selection in a user interface for a multi-feature edit system in accordance with disclosed embodiments;

FIG. 4 illustrates a display of feature definition of a selected part in a user interface for a multi-feature edit system in accordance with disclosed embodiments;

FIG. 5 illustrates a display of a modified assembly in a user interface for a multi-feature edit system in accordance with disclosed embodiments;

FIGS. 6-9 illustrate display of paint parameters to enable a user to identify or locate similar features within the same part or across an assembly of parts or multiple large assembly components and to modify and update feature attributes of some or all of those similar features in a user interface for a multi-feature edit system in accordance with disclosed embodiments; and

FIG. 10 illustrates a flowchart of a process for editing features in accordance with disclosed embodiments.

### DETAILED DESCRIPTION

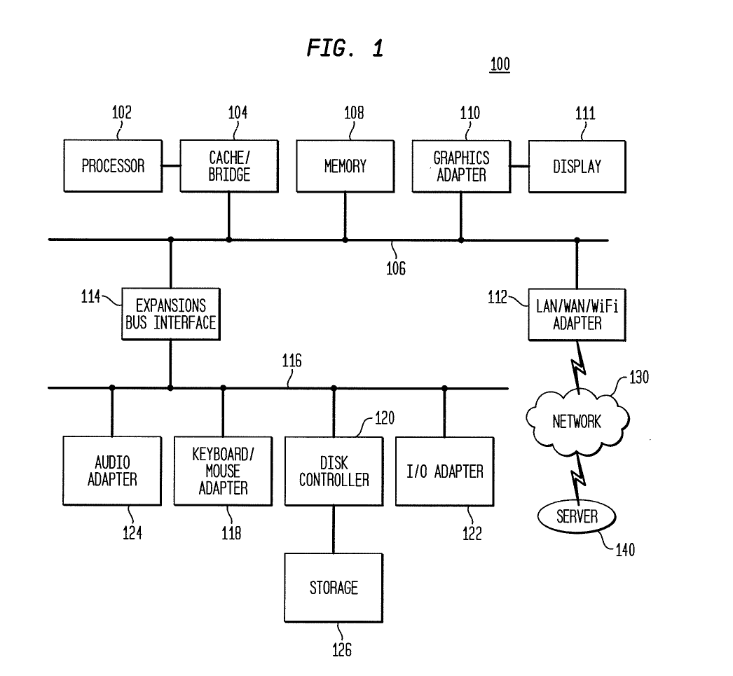

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Parts and assemblies in marine industries, aerospace industries, and casings for many industries often contain a large number of features. Many of these features are of either similar type or share a set of common attributes, or of different type and yet share many common attributes. These features are often created from reference frames of the assemblies or parts. These features need to be editable independent from each other and yet many times have to be modified together to maintain design requirements. Though these features/parts may be created using simple commands on reference frames, the numbers of parts/features created thus explode exponentially in number with the assemblies. It later becomes extremely cumbersome to locate and modify these parts/features. Disclosed embodiments provide systems and methods to identify and modify similar features within the same part or across multiple large assembly components.

FIG. 1 depicts a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments provide systems and methods to enable users to identify or locate similar features within the same part or across multiple large assembly components and to modify and update some or all of those similar features.

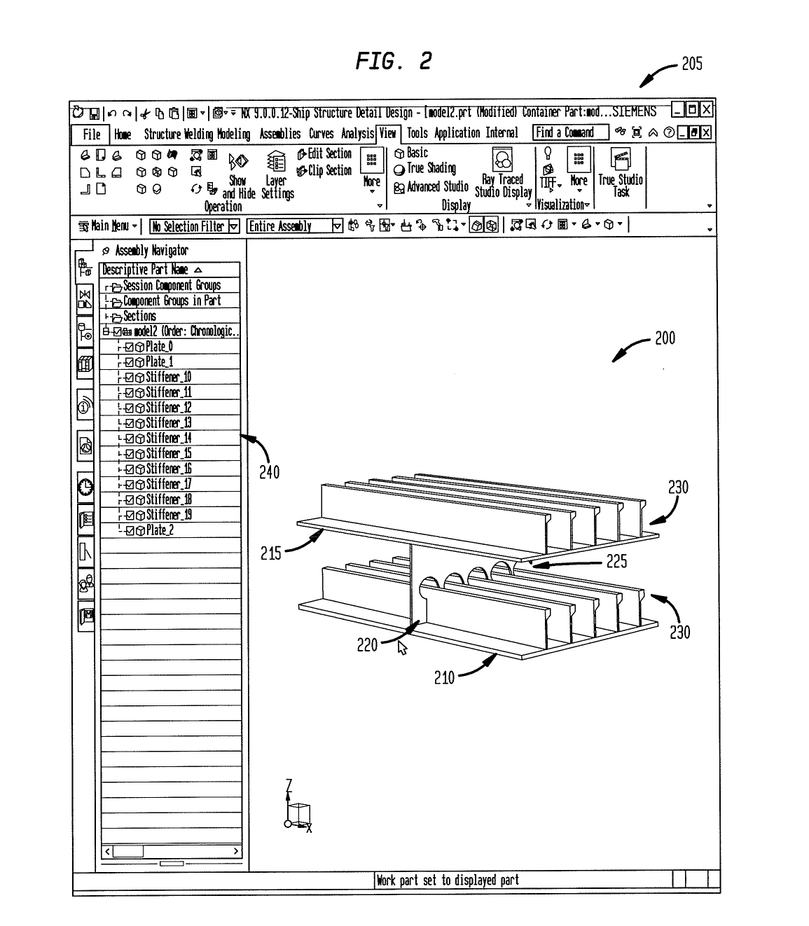

FIG. 2 illustrates a display of an assembly 200 in a user interface 205 for a multi-feature edit system in accordance with disclosed embodiments. In this illustrative embodiment, the user interface 205 is a user interface for a multi-feature edit system that is displayable on the display 111 of FIG. 1. The assembly 200 includes a plurality of parts, each part having one or more features, and each part including one or more feature attributes. The assembly 200 includes a bottom plate 210, a top plate 215, an intermediate plate 220, and a plurality of stiffeners 230. The intermediate plate 220 includes a plurality of cutouts 225 through which a corresponding stiffener of the plurality of stiffeners 230 extends. In a particular embodiment, there may be a dependency relationship between parts and/or features. For example, a shape of one or more of the cutouts 225 may depend on a type of stiffener 230 that goes through it, such that if a stiffener is changed, then the shape of a corresponding cutout will change.

Although many of the parts may look the same and/or have the same or similar dimensions, each part is unique and is created separately. For example, each of the plurality of stiffeners 230 may share many common feature attributes such as being made from the same material, having similar dimensions, having the same or similar orientation settings, etc. However, each of the parts is in a separate, different part file from another part. To illustrate, each part on a list 240 of parts in the user interface 205 represents a different part file on an operating system. In order to make changes to parts having similar features and/or similar feature attributes, a user would have to manually modify each separate part file of the parts that have the similar features. It is desirable to be able to identify and modify similar features within the same part or across multiple large assembly components without having to manually modify each separate part file.

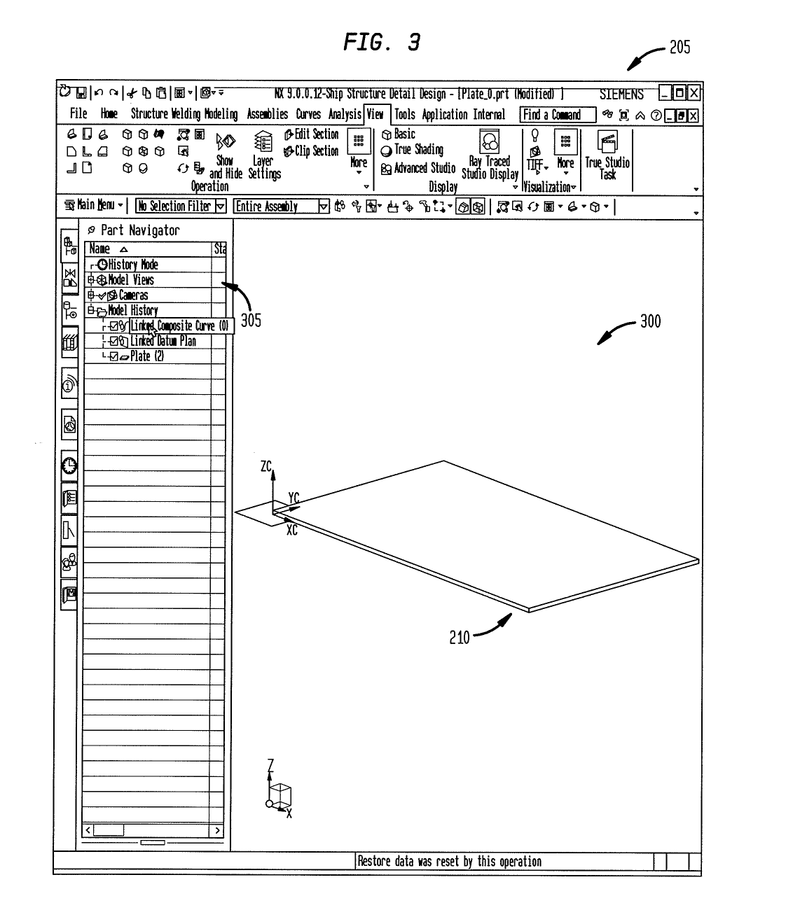

FIG. 3 illustrates a display of part selection 300. For example, a user may wish to modify feature attributes of a selected part, such as a stiffener, a plate, an end cut, an edge cut, a profile cutout, or a weld as non-limiting examples. In the illustrated example, the user may wish to modify feature attributes of the bottom plate 210 of FIG. 2. The display of part selection 300 includes a display of the bottom plate 210 in the user interface 205. The user interface 205 includes a part navigator menu 305. The part navigator menu 305 includes a plurality of features that represent building blocks of a 3-dimensional model of the selected part. In the illustrated example, the features include a linked composite curve, a linked data plane, and a plate. After the user selects the part to be modified, the user may then select the feature attributes of the part to be modified.

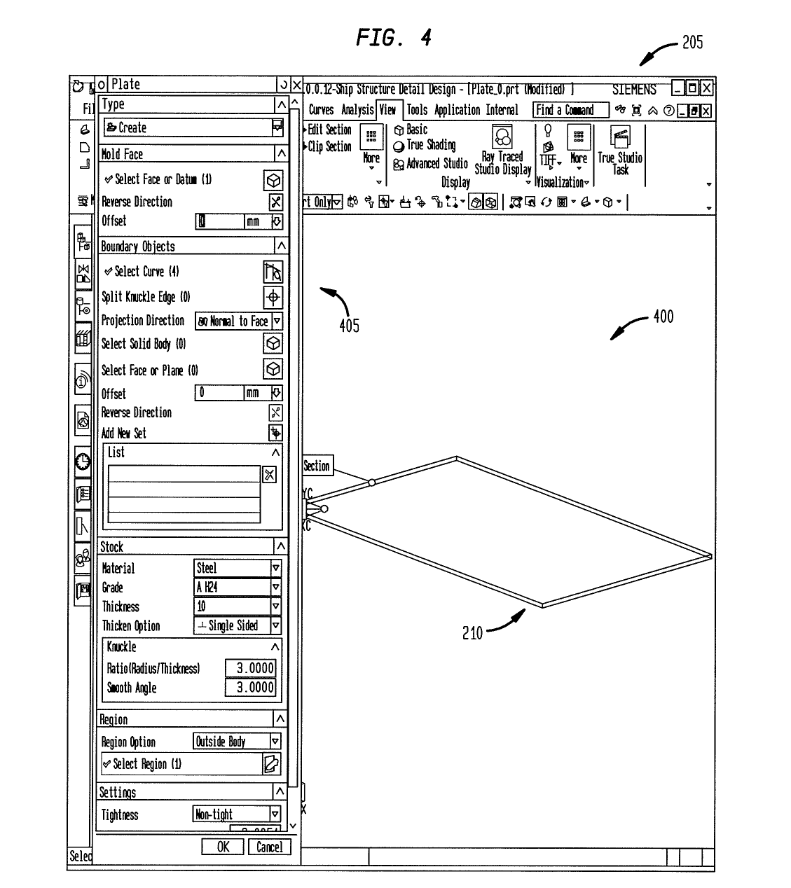

FIG. 4 illustrates a display of feature definition 400 of the selected part (e.g., the bottom plate 210 of FIG. 3 selected via the part navigator menu 305) in the user interface 205. The user interface 205 includes a feature definition menu 405. The feature definition menu 405 includes a plurality of feature attributes that a user can select from to generate and modify the selected part. For example, the feature definition menu 405 may include feature attributes such as section type, size, dimensions, orientation settings, limits, offsets, tolerances, manufacturing stocks and material information as non-limiting examples. To illustrate, if the user wishes to modify the material of the bottom plate 210 from steel to aluminum and the thickness of the bottom plate 210 from 10 mm to 25 mm, the user may do so by clicking on those feature attributes in the feature definition menu 405.

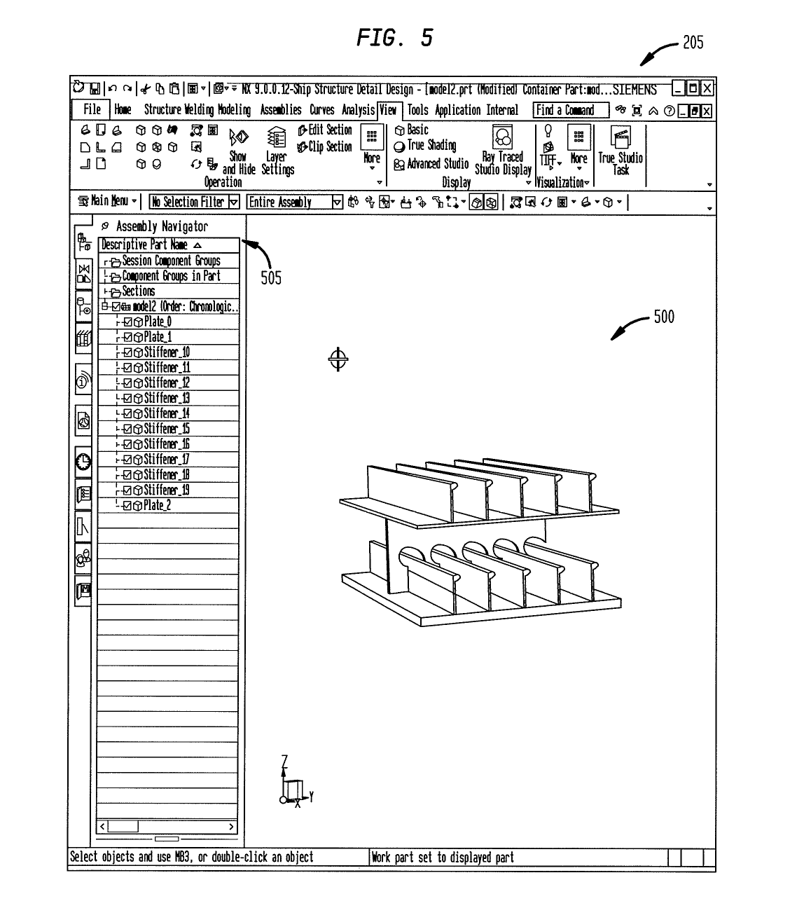

FIG. 5 illustrates a display of a modified assembly 500 in the user interface 205. The modified assembly 500 corresponds to the assembly 200 of FIG. 2 and illustrates that a thickness of the bottom plate 210 has been modified via the feature definition menu 405 of FIG. 4.

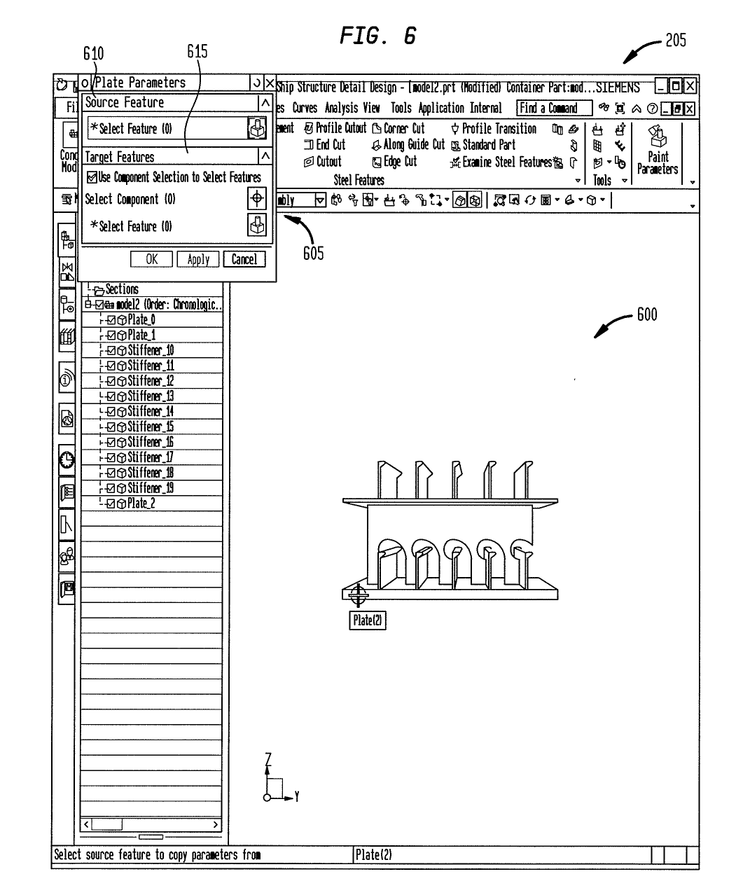

FIGS. 6-9 illustrate display of paint parameters to enable a user to identify or locate similar features within the same part or across an assembly of parts or multiple large assembly components and to modify and update features and feature attributes of some or all of those similar features. For example, the user interface 205 includes a paint parameter menu 605. The paint parameter menu 605 includes options for selection of a source feature 610 and selection of a target feature 615. The source feature 610 corresponds to the part on which one or more feature attributes have been modified as described with respect to FIGS. 3-5 above. The target feature 615 corresponds to the same part, to an assembly of parts, or to multiple assemblies of parts having a feature similar to the feature whose one or more feature attributes has been modified. For example, in the illustrated embodiment, the source feature 610 corresponds to the bottom plate 210 and the one or more feature attributes corresponds to the thickness of the bottom plate 210.

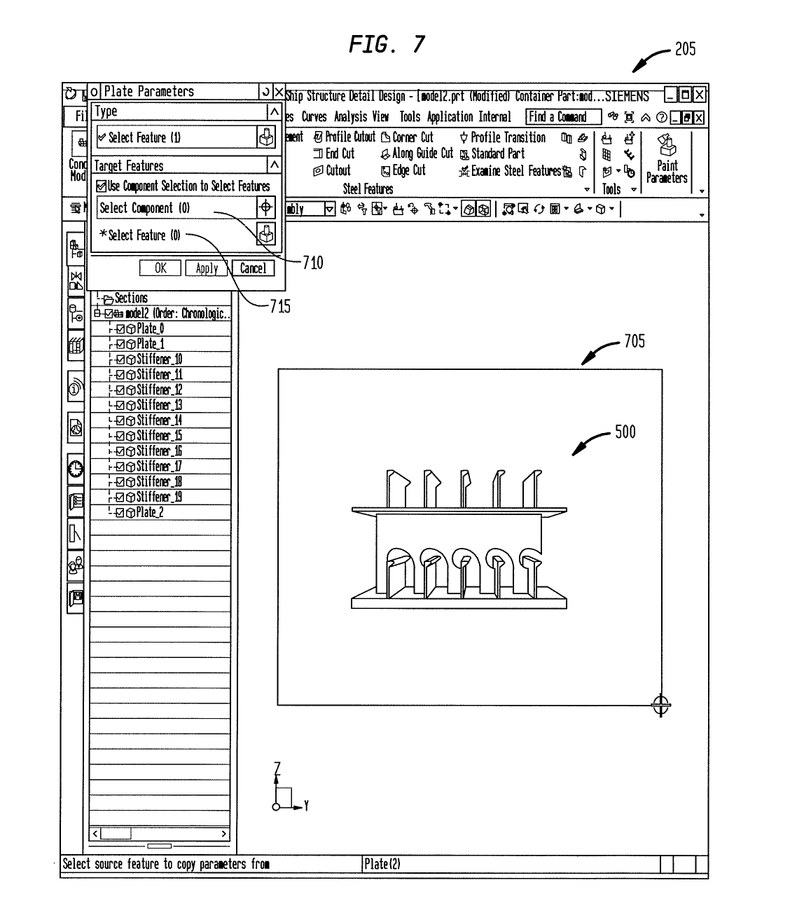

The target feature 615 may be selected by the user within the same part or any assembly of parts. For example, selection of the target feature 615 may include a select component option 710 and a select feature option 715 (as illustrated in FIG. 7). In the illustrated embodiment, selection of the target feature 615 is via the select component option 710. A selection window 705 displayed in the user interface 205 enables the user to select compatible target features within the part or assembly. A compatible target feature includes a feature that is of a same or of a similar type as the source feature, or a user can select features that should be considered compatible or the criteria for identifying compatible features. For example, as illustrated, the selection window 705 encompasses the modified assembly 500 of FIG. 5. As such, the features of the modified assembly 500 are searched to determine whether there are features that are of the same or of a similar type as the source feature 610. The user can also select only certain features from a part or any assembly component or de-select any unwanted features. The user may also select the target feature 615 from the part navigator menu 305 of FIG. 3 or from an assembly navigator menu 505 of FIG. 5.

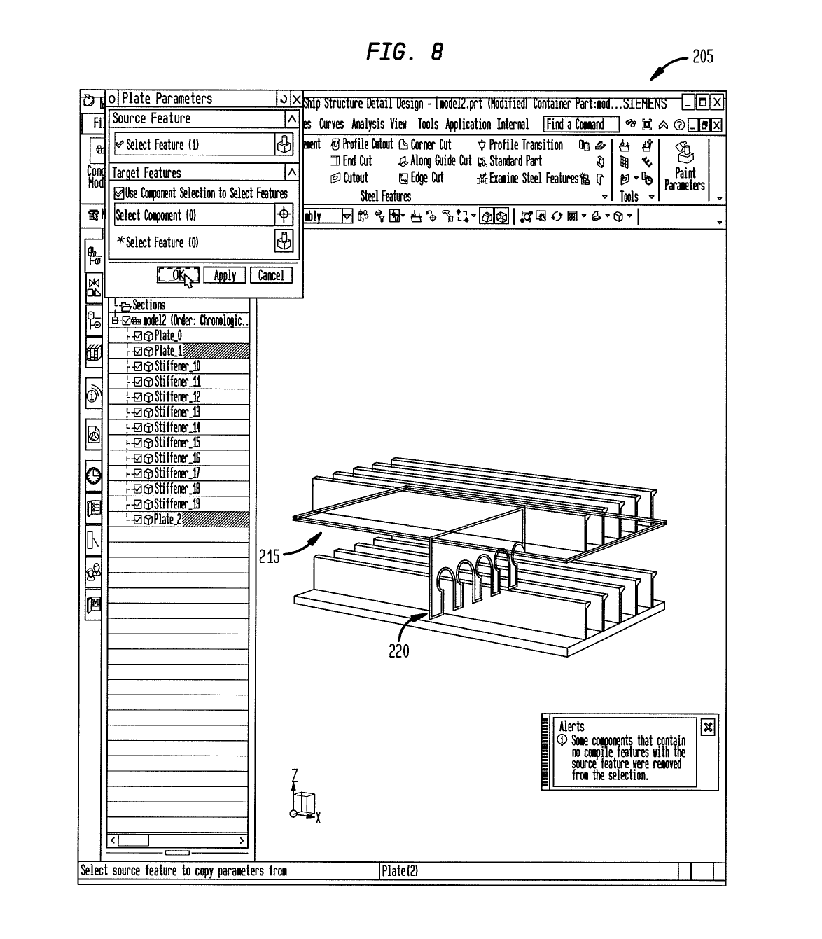

Once the user identifies the target features 615 that need to be made similar to the source feature 610, a system, such as the data processing system of FIG. 1, is configured to find any features within selected compatible target features that are similar to the source feature, and will change the feature attributes of similar target features to make them similar to the corresponding feature attributes of the source feature. These features and the corresponding parts may be marked as modified in the system. When the feature attributes of the target features are changed, the features, parts, and/or assemblies may be updated in a “bottom-up” manner in accordance with a dependency order of these features/parts/assemblies. For example, a bottom-up approach is being utilized when off-the-shelf or existing components are selected and integrated into a product. An example would include selecting a particular fastener, such as a screw, and designing a component that receives the screw such that the screw will fit properly. To illustrate, a shape of one or more of the cutouts 225 of FIG. 2 may depend on a type of stiffener 230 that goes through it, such that if a stiffener is changed, then the shape of a corresponding cutout will change. Thus, several features in various parts/assemblies are updated with minimal user intervention. If there are some feature update failures, the user may be presented with an option to run a diagnostic tool to correct the failures. Errors could also occur in parts that have a dependency relationship with the parts that were selected (e.g., the source feature). In addition, if the user tries to “paint” between two features of different type or if there are some components that contain no compatible features with the source feature, then an alert may be raised to inform the user as illustrated in FIG. 8.

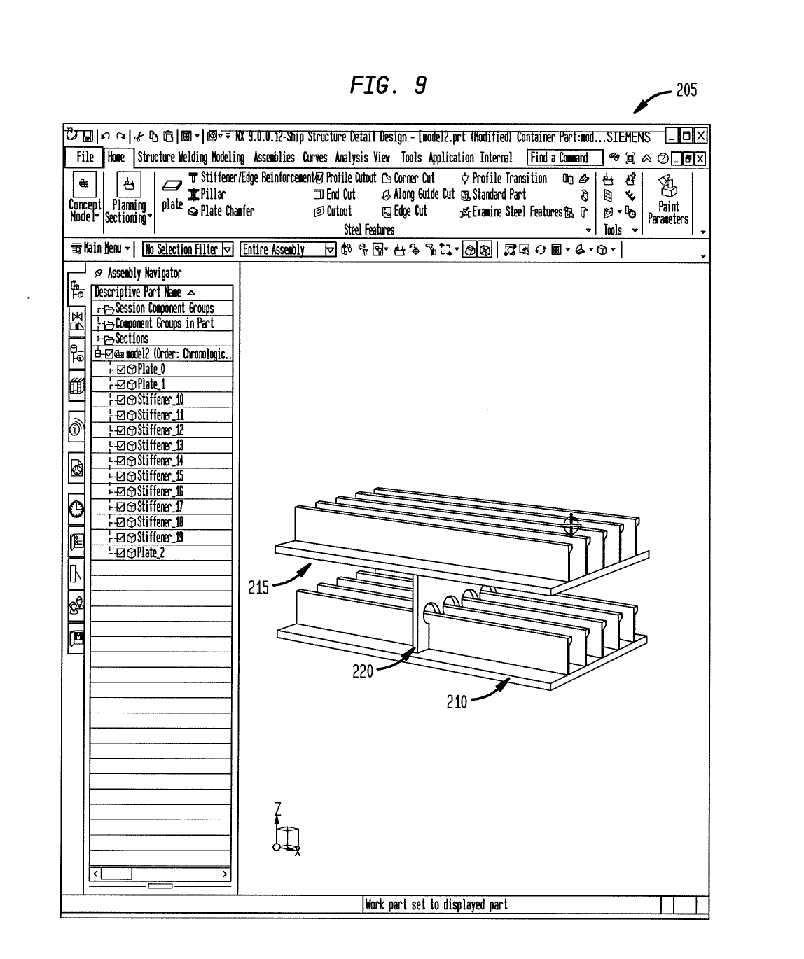

For example, in the illustrated embodiment, the top plate 215 and the intermediate plate 220 (indicated as highlighted in FIG. 8) have been identified as features that are similar to the source feature 610 (e.g., the bottom plate 210). As illustrated in FIG. 9, one or more of the feature attributes of the top plate 215 and the intermediate plate 220 may have been painted or changed in accordance with corresponding feature attributes of the source feature 610 (e.g., the bottom plate 210). In addition, in the illustrated example, a modified feature attribute (e.g., a thickness) of the source feature 610 (e.g., the bottom plate 210) has been painted from the source feature 610 to the target features 615 (e.g., the top plate 215 and the intermediate plate 220) such that the thickness of the top plate 215 and the thickness of the intermediate plate 220 are the same as the thickness of the bottom plate 210. In this example, if the modifications are accepted by the user, the parts files that include the top plate 215, the intermediate plate 220, and the bottom plate 210 would be updated and may be marked as modified.

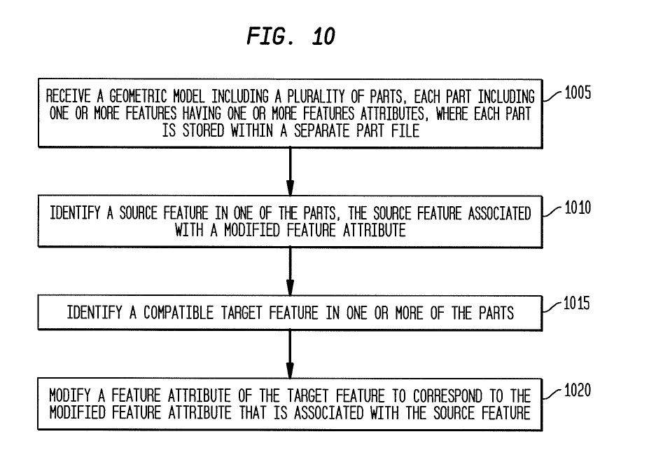

FIG. 10 illustrates a flowchart of a process in accordance with disclosed embodiments that may be performed, for example, by a PLM or PDM system.

The system receives a geometric model including a plurality of parts, at step 1005. Each part includes one or more features having one or more feature attributes. Each part is stored within a separate part file. For example, the plurality of parts may be the assembly 200 of FIG. 2, the feature attributes may include the feature attributes in the feature definition menu 405 of FIG. 4, including but not limited to section type, size, dimensions, orientation settings, limits, offsets, tolerances, manufacturing stocks and material information, and the separate part file may be represented by each part on the part list 240 of FIG. 2. “Receiving,” as used herein, can include loading from storage, receiving from another device or process, receiving via an interaction with a user, and otherwise.

The system identifies a source feature in one of the parts, at step 1010. The source feature is associated with a modified feature attribute. For example, as part of this step, the system may receive a user input including a feature having a feature attribute that has been modified and that has been designated as a source feature. For example, the source feature may be the source feature 610 of FIG. 6. The “modification” of the source feature attribute is not necessarily performed at the same time as the other processes described herein, but can be a modification made at a time previous to the “painting” process.

The system identifies a compatible target feature in one or more of the parts, at step 1015. For example, as part of this step, the system may receive a user input including a target feature that needs to be made similar to the source feature. For example, the target feature may be the target feature 615 of FIG. 6.

The system modifies a feature attribute of the target feature to correspond to the modified feature attribute that is associated with the source feature, at step 1020. For example, once the target feature is identified, the system is configured to find any features within selected compatible target features that are similar to the source feature, and will change the feature attributes of similar target features to make them similar to the source feature. When the feature attributes of the target features are changed, the features, parts, and/or assemblies may be updated in a “bottom-up” manner in accordance with a dependency order of these features/parts/assemblies.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for editing features, the method performed by a data processing system and comprising:
receiving, by the data processing system, a geometric model including a plurality of parts, each part including one or more features having one or more feature attributes, wherein each part is stored within a separate part file;
identifying a source feature in one of the parts, the source feature associated with a modified feature attribute;
identifying a compatible target feature in one or more of the parts; and
modifying, by the data processing system, a feature attribute of the target feature to correspond to the modified feature attribute that is associated with the source feature.

2. The method of claim 1, further comprising:
detecting a dependency order of features in the model; and
modifying the target feature according to the dependency order.

3. The method of claim 1, further comprising:
storing the modified feature attribute of the target feature by the data processing system.

4. The method of claim 1, further comprising:
marking the target feature having the modified feature attribute and any part corresponding to the target feature that has the modified feature attribute as modified.

5. The method of claim 1, wherein each feature is configured to be edited independent from another feature.

6. The method of claim 1, wherein identifying the compatible target feature comprises:
filtering for the compatible target feature; and
highlighting the target feature to be modified.

7. The method of claim 1, wherein the one or more features include a stiffener, a plate, an end cut, an edge cut, a profile cutout, or a weld.

8. A data processing system comprising:
a processor; and
an accessible memory, the data processing system particularly configured to:
receive, by the data processing system, a geometric model including a plurality of parts, each part including one or more features having one or more feature attributes, wherein each part is stored within a separate part file;
identify a source feature in one of the parts, the source feature associated with a modified feature attribute;
identify a compatible target feature in one or more of the parts; and
modify, by the data processing system, a feature attribute of the target feature to correspond to the modified feature attribute that is associated with the source feature.

9. The data processing system of claim 8, wherein the data processing system is further configured to:
detect a dependency order of features in the model; and
modify the target feature according to the dependency order.

10. The data processing system of claim 8, wherein the data processing system is further configured to:
store the modified feature attribute of the target feature.

11. The data processing system of claim 8, wherein, the data processing system is further configured to:
mark the target feature having the modified feature attribute and any part corresponding to the target feature that has the modified feature attribute as modified.

12. The data processing system of claim 8, wherein each feature is configured to be edited independent from another feature.

13. The data processing system of claim 8, wherein the data processing system is further configured to:
filter for the compatible target feature; and
highlight the target feature to be modified.

14. The data processing system of claim 8, wherein the one or more features include a stiffener, a plate, an end cut, an edge cut, a profile cutout, or a weld.

15. A non-transitory computer-readable medium encoded with executable instructions for editing features that, when executed, cause one or more data processing systems to:
receive a geometric model including a plurality of parts, each part including one or more features having one or more feature attributes, wherein each part is stored within a separate part file;
identify a source feature in one of the parts, the source feature associated with a modified feature attribute;
identify a compatible target feature in one or more of the parts; and
modify a feature attribute of the target feature to correspond to the modified feature attribute that is associated with the source feature.

16. The computer-readable medium of claim 15 further comprising instructions that cause the data processing system to:
detect a dependency order of features in the model; and
modify the target feature according to the dependency order.

17. The computer-readable medium of claim 15 further comprising instructions that cause the data processing system to:
store the modified feature attribute of the target feature.

18. The computer-readable medium of claim 15 further comprising instructions that cause the data processing system to:
mark the target feature having the modified feature attribute and any part corresponding to the target feature that has the modified feature attribute as modified.

19. The computer-readable medium of claim 15, wherein each feature is configured to be edited independent from another feature.

20. The computer-readable medium of claim 15, further comprising instructions that cause the data processing system to:
filter for the compatible target feature; and
highlight the target feature to be modified.
